(19) United States
(12) Patent Application Publication
(10) Pub. No.: US 2008/0280279 A1
(43) Pub. Date: Nov. 13, 2008

(54) System and Method for Supporting Lecture Room on the Basis of Ubiquitous

(76) Inventors: Young Chul Jang, Seoul (KR); Jimin Jang, Seoul (KR)

Correspondence Address: PARK LAW FIRM, 3255 WILSHIRE BLVD, SUITE 1110, LOS ANGELES, CA, 90010, US

(21) Appl. No.: 12/159,479

(22) PCT Filed: Dec. 28, 2006
(86) PCT No.: PCT/KR2006/005918

§ 371 Date: Jun. 27, 2008

(30) Foreign Application Priority Data
Dec. 28, 2005 (KR) 10-2005-0131397

(51) Int. Cl. G09B 3/00; G09B 5/10

(52) U.S. Cl. 434/308; 434/351

(57) ABSTRACT

The present invention relates to a system and method for supporting a two-way lecture (also called a bi-directional lecture) suitable for the Ubiquitous educational environment, and more particularly to a system and method for supporting an interactive two-way lecture suitable for the Ubiquitous educational environment.

### TECHNICAL FIELD

The present invention relates to a system and method for supporting a two-way lecture (also called a bi-directional lecture) suitable for the Ubiquitous educational environment, and more particularly to a system and method for supporting an interactive two-way lecture suitable for the Ubiquitous educational environment, which recognize the presence or absence of students (or trainees) via wireless terminals installed at individual student-seats of a lecture room, control a corresponding student-seat terminal to be intimately interoperable with a lecturer-seat terminal, reduce a time consumed for checking the presence or absence of the students, increase efficiency of medium- or large-sized lectures, minimize the number of divided classes, and improve the quality of lectures.

### BACKGROUND ART

A conventional authentication system for checking the presence or absence of students will hereinafter be described with reference to FIG. 1.

FIG. 1 is a conceptual diagram illustrating the conventional authentication system for checking the presence or absence of students.

Referring to FIG. 1, the conventional authentication system for checking the presence or absence of students includes an authentication unit 14 and a central management unit 13. The authentication unit 14 is generally installed at an entrance of a specific room 10 (e.g., a lecture room, a conference room, a classroom, and a seminar room) in which a plurality of persons are collected at a predetermined time to execute the same task, such that it authenticates whether the students attend a lecture. The central management unit 13 communicates with the above-mentioned authentication unit by wire or wirelessly to receive specific information indicating the authentication or non-authentication of the students from the authentication unit 14, and manages attendance states of the students on the basis of the received information.

In this case, the authentication unit 14 may be implemented with a variety of bionic information (e.g., fingerprint, iris, and voice). For the convenience of description, an authentication device based on fingerprint information will hereinafter be described as a representative example of the above-mentioned authentication unit 14.

The above-mentioned authentication device for use of the fingerprint information is classified into a first type in which a transmitter and a receiver are integrated in a single unit and a second type in which a transmitter and a receiver are separated from each other. For the convenience of description, the first type is called a transmitter/receiver integration type, and the second type is called a transmitter/receiver separation type. In other words, in the case of the transmitter/receiver integration type, a receiver for receiving user's fingerprint information is integrated with a controller for performing user authentication. In the case of the transmitter/receiver separation type, a transmitter (i.e., a wireless authentication key) 12 for receiving fingerprint information from the user is separated from a controller 11 for performing user authentication or transmitting the transmission result of the wireless authentication key, as shown in FIG. 1.

In the case of the transmitter/receiver integration type, a process for authenticating all the users is performed in the integrated-type authentication system. In the case of the transmitter/receiver separation type, if the transmitter 11 receives user's fingerprint information, and transmits the received user's fingerprint information to a repeater (i.e., controller 11), the repeater (i.e., the controller) 11 performs user authentication.

However, the above-mentioned conventional authentication system for checking the presence or absence of students has difficulty in effectively checking the presence or absence of students on the condition that a large number of students attend a lecture.

In more detail, the repeater 11 is generally mounted to an entrance door of a lecture room. Provided that a large number of students are collected at the lecture room just prior to the beginning of the lecture, the students must wait for their entrance order, must mark their attendance at the lecture, and must enter the lecture room, resulting in greater inconvenience of the students.

In this case, if the repeater 11 is configured in the form of the transmitter/receiver separation type, the conventional authentication system for checking the presence or absence of the students may perform the user authentication process using a wireless communication function at a predetermined distance spaced apart from the student. However, in this case, the repeater 11 has difficulty in performing the user authentication at the same time, such that it cannot perfectly perform numerous authentication processes at the same time.

The above-mentioned conventional authentication system of FIG. 1 may have an undesired student (i.e., an idle student) who does not enter a lecture room after checking only the presence or absence of the students using the repeater 11 prior to the beginning of a lecture, such that it invites all the students to record their presence or absence at the lecture. However, in this case, a large number of students are simultaneously collected to record their presence at the authentication system, such that unexpected great confusion of the students may occur.

### DISCLOSURE

### Technical Problem

Therefore, the present invention has been made in view of the above problems, and it is an object of the present invention to provide a system and method for supporting a two-way lecture (also called a bi-directional lecture) suitable for the Ubiquitous educational environment, which control a lecture-support server to automatically recognize the presence or absence of at least one student via wireless terminals installed at individual student-seats of a lecture room, prevent a proxy attendance from being generated, and prevent the beginning time of a lecture from being delayed due to the occurrence of wasted time.

It is another object of the present invention to provide a system and method for supporting a two-way lecture suitable for the Ubiquitous educational environment, which control a plurality of student-seat terminals to be intimately interoperable with a lecturer-seat terminal, increase efficiency of medium- or large-sized lectures, minimize the number of divided classes, and improve the quality of lectures.

### Technical Solution

In accordance with one aspect of the present invention, the above and other objects can be accomplished by the provision of a system for supporting a two-way lecture suitable for Ubiquitous educational environments comprising: a wireless-type student-seat terminal which is installed at each student-seat of a lecture room, reads student information from a student card of a student who has sat on the student-seat, wirelessly transmits attendance information including the student information and student-seat information to an external part, wirelessly receives attendance-authentication confirmation information, and displays attendance status information on a lecture-information display; a lecture repeater for switching data communication between the student-seat terminal and an external wired device; a lecture-support server for receiving the attendance information from the student-seat terminal via the lecture repeater, registering the attendance information to perform attendance authentication, transmitting the attendance-authentication confirmation information to the student-seat terminal via the lecture repeater, changing a current status of the student-seat terminal to an attendance status, including the attendance-authentication confirmation information in student's detailed information of the student-seat terminal of the lecture room, and storing the student's detailed information; and a lecturer-seat terminal which is installed at each student-seat of the lecture room, reads attendance status information of each student-seat and detailed information of the student who has sat on the student-seat from the lecture-support server, allows a lecturer to recognize the attendance status information and the student's detailed information, and progresses the lecture by communicating with the student-seat terminal via the lecture repeater.

In accordance with another aspect of the present invention, there is provided a method for supporting a two-way lecture suitable for Ubiquitous educational environments comprising: a) reading, by a student-seat terminal installed at each student-seat of a lecture room, student information from a student card of a student who has sat on the student-seat, and wirelessly transmitting attendance information including the student information and student-seat information to an external lecture-support server; b) wirelessly receiving, by the student-seat terminal, attendance-authentication confirmation information from the lecture-support server, and displaying attendance status information on a lecture-information display; c) receiving, by the student-seat terminal, a question request from the student via a question button, wirelessly transmitting question information including corresponding student information and student-seat information to the lecturer-seat terminal in order to allow question status information to be received in the lecturer-seat terminal, and displaying question-receipt status information on the lecture-information display; d) wirelessly receiving, by the student-seat terminal, quiz-occurrence information from the lecturer-seat terminal, indicating that the corresponding student is indicative of a quiz target using the lecture-information display, transmitting quiz-response information of the student selected by a response button to the lecturer-seat terminal, and displaying quiz-marking status information on the lecture-information display; and e) inviting, by the student-seat terminal, the student to select a single response button from among response buttons arranged in numerical order at a termination time of the lecture, configuring student's selection information in the form of lecture-understanding estimation information of the lecture, and wirelessly transmitting the lecture-understanding estimation information to the lecturer-seat terminal and the lecture-support server.

In accordance with yet another aspect of the present invention, there is provided a method for supporting a two-way lecture suitable for Ubiquitous educational environments comprising: a) receiving, by a lecture-support server, attendance information wirelessly transmitted from a student-seat terminal installed at each student-seat of a lecture room; b) comparing, by the lecture-support server, a reception time of the attendance information with a lecture-beginning time, determining whether the attendance information indicates the occurrence of a tardy student, authenticating the attendance information as tardy attendance when the received attendance information indicates the occurrence of the tardy student, authenticating the attendance information as prompt attendance when the received attendance information does not indicate the tardy student, and storing the authenticated information; c) transmitting, by the lecture-support server, attendance-confirmation information based on the attendance-information authentication result to the student-seat terminal, and changing a current status of the student-seat terminal to an attendance status; d) extracting, by the lecture-support server, lecture-progression information including a current attendant- or absent-student situation result acquired by the attendance-authentication step at a lecture-beginning time, transmitting the extracted lecture-progression information to a lecturer-seat terminal, and allowing a lecturer to recognize detailed information of the attendant- or absent-student via the lecturer-seat terminal; e) if the student-seat terminal transmits a student's question to the lecturer-seat terminal during the lecture in the lecture room, receiving, by the lecture-support server, question report information of the student from the lecturer-seat terminal, and storing the question report information; f) if a quiz of the lecturer is transmitted from the lecturer-seat terminal to the student-seat terminal during the lecture in the lecture room, receiving quiz-progression result report information including the quiz and quiz-marking information of the student who has answered the quiz from the lecturer-seat terminal, and storing the quiz-progression result report information; g) if the lecturer estimates the degree of the lecture-understanding of each student using the lecturer-seat terminal after receiving a student's answer from the student-seat terminal during the lecture in the lecture room, receiving the lecture-understanding estimation information of the student from the student-seat terminal or the lecturer-seat terminal, and storing the lecture-understanding estimation information of the student; and h) receiving, by the lecture-support server, student-attitude report information from the lecturer-seat terminal, and storing the student-attitude report information.

### ADVANTAGEOUS EFFECTS

The system and method for supporting a two-way lecture (also called a bi-directional lecture) suitable for the Ubiquitous educational environment according to the present invention control the lecture-support server to automatically recognize the presence or absence of at least one student via wireless terminals installed at individual student-seats of a lecture room, prevent a proxy attendance from being generated, and prevent the beginning time of a lecture from being delayed due to the occurrence of wasted time.

The system according to the present invention monitors the presence or absence of fraudulent behavior of the student during the lecture, and registers/manages the fraudulent behavior of the student who has left the lecture room without notice to the lecturer, such that it can prevent the student from leaving the lecture room after the student has registered his or her attendance, differently from the conventional student's attendance management system.

The system refers to lecture-progression information transmitted from the lecture-support server to the lecturer-seat terminal at the beginning time of the lecture, and the lecturer of the lecture room can recognize information of all the students, i.e., names, faces, and current seat locations of the students. Furthermore, the above-mentioned lecture-progression information further includes a department, a student number, attendance information, lecture-participation status, and question-participation status of the current attendant, such that the lecturer can also recognize detailed information of the students who participate in the lecture, resulting in the implementation of a systemized lecture suitable for a large-sized lecture room. There is no need to divide a large-scale lecture into a plurality of small-scale lectures, such that the system solves dissatisfaction between the lecturer and the students during a large-scale lecture, resulting in the reduction of management costs and personnel expenses.

The system according to the present invention allows each student-seat terminal to transmit a question to the lecturer-seat terminal, and allows the lecturer-seat terminal to receive the question from the student-seat terminal, such that the student can inform the lecturer of his or her question without breaking the flow of the lecture during the lecture using the student-seat terminal of the student. The lecturer completes his or her explanation without interruption, checks the occurrence of the student's question via the lecturer-seat terminal, and answers the question, thereby facilitating the flow of the lecture. The system according to the present invention invites the lecturer-seat terminal to automatically generate the quiz during the lecture, allows the lecturer-seat terminal to automatically mark the student's answer to the quiz, can naturally give the student the warning- or call-signal, and can easily recognize the degree of lecture-understanding information of each student after the lecture is terminated, such that it can naturally proceed the lecture, and educational matters and learning management can be facilitated.

### DESCRIPTION OF DRAWINGS

The above and other objects, features and other advantages of the present invention will be more clearly understood from the following detailed description taken in conjunction with the accompanying drawings, in which:

FIG. 1 is a conceptual diagram illustrating a conventional authentication system for checking the presence or absence of students;

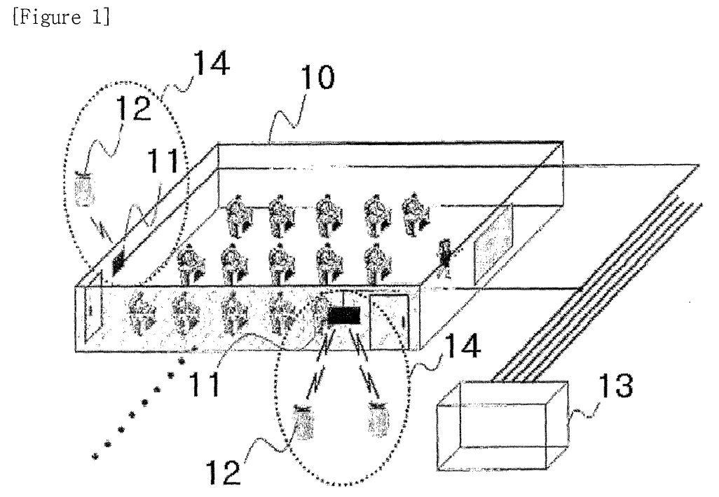

FIG. 2 is a conceptual diagram illustrating a system for supporting a two-way lecture suitable for the Ubiquitous educational environment according to the present invention;

FIG. 3 exemplarily shows a student-seat terminal according to the present invention;

FIG. 4 is a block diagram illustrating a student-seat terminal according to the present invention;

FIG. 5 is a block diagram illustrating a lecture repeater according to the present invention;

FIG. 6 exemplarily shows a main image of a lecturer-seat terminal according to the present invention;

FIG. 7 exemplarily shows a student's detailed information checkup image of a lecturer-seat terminal according to the present invention;

FIG. 8 exemplarily shows an absentee information checkup image of a lecturer-seat terminal according to the present invention;

FIG. 9 is a block diagram illustrating a lecture-support server according to the present invention;

FIG. 10 is a flow chart illustrating a method for supporting a two-way lecture suitable for the Ubiquitous educational environment according to a first preferred embodiment of the present invention; and

FIG. 11 is a flow chart illustrating a method for supporting a two-way lecture suitable for the Ubiquitous educational environment according to a second preferred embodiment of the present invention.

### BEST MODE

Now, preferred embodiments of the present invention will be described in detail with reference to the annexed drawings.

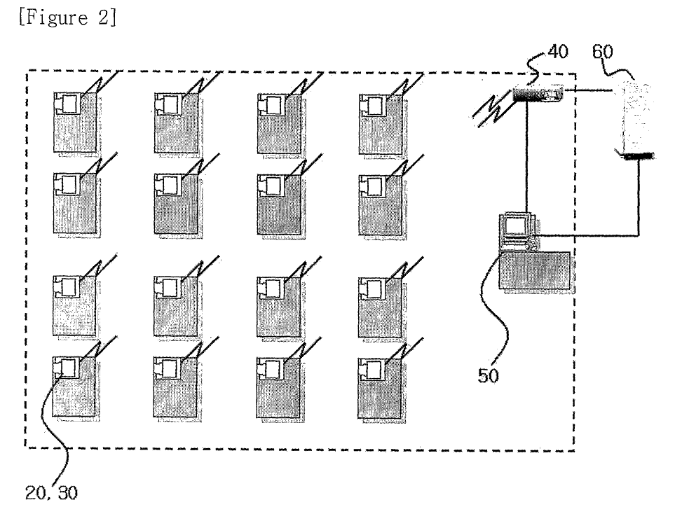

FIG. 2 is a conceptual diagram illustrating a system for supporting a two-way lecture suitable for the Ubiquitous educational environment according to the present invention.

Referring to FIG. 2, the system for supporting the two-way lecture suitable for the Ubiquitous educational environment includes: a student card 20 owned by a student; a student-seat terminal 30 installed at each student seat of a lecture room; a lecture repeater 40 installed at the lecture room such that it performs the switching of RF data (i.e., wireless information) between the student-seat terminal 30 and an external part; a lecturer-seat terminal 50 installed at a lecturer's seat of the lecture room; and a lecture-support server 60 for supporting a lecture progress by communicating with the student-seat terminal 30 and the lecturer-seat terminal 50.

Firstly, the student card 20 is carried by each of students who attend the lecture, and stores student information capable of recognizing a corresponding student. In this case, the student information includes at least one of a name, a student number, a resident registration number, and a card number of the corresponding student.

In this case, the student card 20 may be a contact card (also called a contact-type card) capable of recognizing the corresponding card via a physical contact between the card reader and a student-card chip, or may be a contactless card (also called a contactless-type card) communicating with the card reader via an antenna by means of a Radio Frequency (RF) signal. In addition, the student card 20 may be a hybrid- or combi-card in which the contact-type card and the contactless-type card are mixed.

Preferably, the student card 20 may be a student identity card configured in the form of a smart card owned by each student.

The student-seat terminal 30 installed at each student seat of the lecture room reads/recognizes information of the student card 20. The student-seat terminal 30 can communicate with the lecturer-seat terminal 50 and the lecture-support server 60 via the lecture repeater 40. The student-seat terminal 30 is placed on each student's desk, is exposed to the outside, and displays a variety of display information based on an external communication result, such that a student of a corresponding student seat can easily recognize the above-mentioned display information.

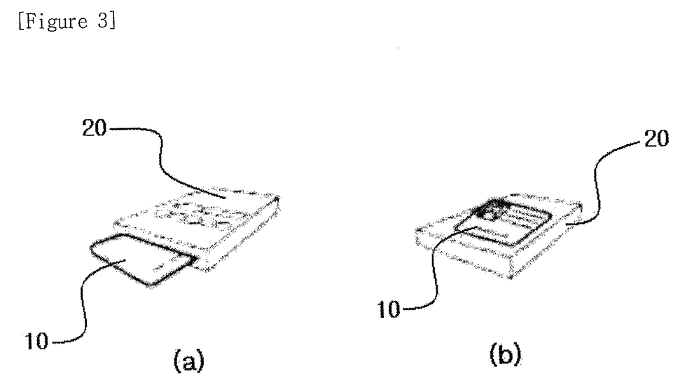

In this case, the above-mentioned student-seat terminal 30 is configured in the form of a contact-type terminal (See FIG. 3(a)) or a contactless-type terminal (See FIG. 3(b)) as depicted in FIG. 3, such that it reads information of the student card 20.

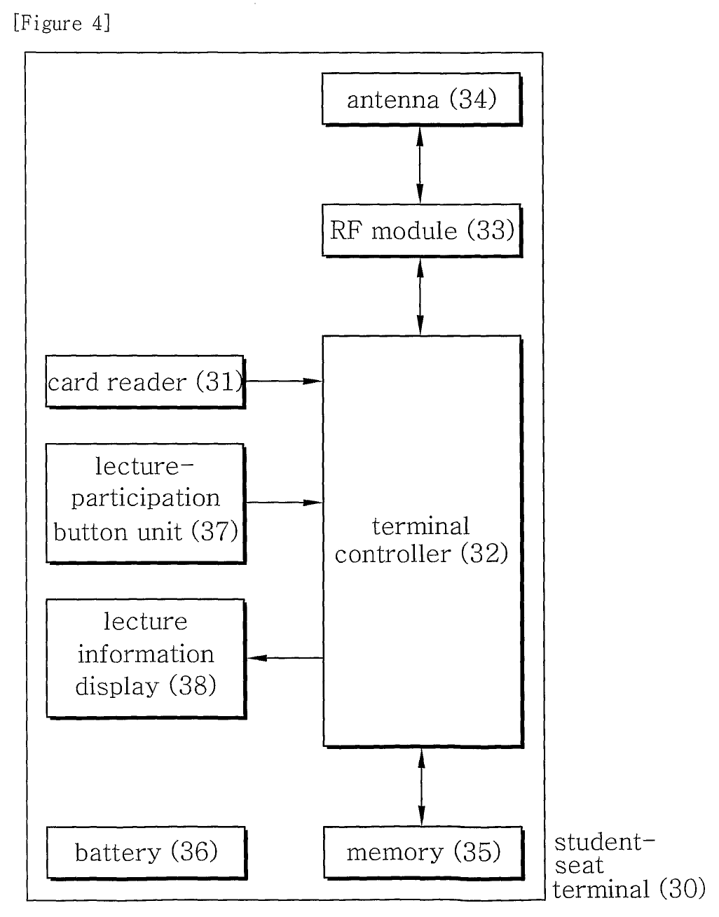

The above-mentioned student-seat terminal 30 will hereinafter be described in detail with reference to FIG. 4.

FIG. 4 is a block diagram illustrating a student-seat terminal according to the present invention.

Referring to FIG. 4, the student-seat terminal 30 includes a card reader 31, a terminal controller 32, a RF module 33, an antenna 34, a memory unit 35, a battery 36, a lecture-participation button unit 37, and a lecture-information display 38.

In more detail, as can be seen from FIGS. 3(a) and 3(b), if a student inserts his or her student card 30 into a corresponding student-seat terminal 30 or controls the student card 20 to be close to the corresponding student-seat terminal 30, the card reader 31 of the student-seat terminal 30 reads lecture information from the corresponding student card 20. Upon receiving a control signal from the terminal controller 32, the RF module 33 converts the recognized student information into RF transmission information, such that the RF transmission information is transmitted to the lecture repeater 40 via the antenna 34. The student information transmitted from the student-seat terminal 30 is transmitted to the lecture-support server 60 via the lecture repeater 40, such that attendance- or absence-information of the corresponding student is registered. Other information transmitted from the lecturer-seat terminal 50 or the lecture-support server 60 to the lecture repeater 40 is received via the antenna 34, such that the received information is converted by the RF module, and the resultant data is transmitted to the terminal controller 32.

In this case, the RF module 33 may establish a transmission target (i.e., the student-seat terminal or the lecture-support terminal) of the corresponding information when the information is transmitted to an external part.

The lecture-participation button unit 37 composed of a plurality of buttons transmits a button-selection signal of the student, who has selected a corresponding button, to the terminal controller 32, and outputs the button-selection signal to the outside, such that it invites a student of a corresponding student seat to participate in a corresponding lecture. The lecture-participation button unit 37 includes a question button and a response button. The question button is used when the student has a question to the lecturer. The response button is used when the student answers a simple quiz of the lecturer during the lecture time. The response button may allow the lecturer to warn a corresponding student of the caution or notice, and may answer a call signal of the corresponding student. In addition, if the lecture is terminated, the response button may display the understanding degree of each student who has attended the corresponding lecture.

The lecture-information display 38 displays a variety of situations required for the lecture progression for the student of the corresponding student seat, such that it displays an attendance-authentication status, a question-information receipt status, a lecturer-quiz status, quiz-marking information, caution/call information, and lecture-termination information. The lecture-information display 38 may include a variety of light emitting diodes (LEDs) having different colors, such that it visually informs the student of necessary information. Otherwise, the lecture-information display 38 may include a buzzer, such that it can audibly inform the student of necessary information.

For example, in the case of the lecture-information display 38, a green lamp blinks a predetermined number of times on the condition that the attendance of a corresponding student has been recognized. The green lamp is switched on when a question of the student is received by the lecturer. If the student unreasonably leaves the lecture room without notice to the lecturer, a red lamp blinks a predetermined number of times. If a quiz is received by the corresponding student, the red lamp is switched on, such that the ON-state red lamp is maintained until the student answers the quiz. If it is determined that the student's response to the quiz is correct, the green lamp is switched on. Otherwise, if it is determined that the student's response to the quiz is incorrect, the red lamp is switched on. If the lecture generates the caution or call signal for the corresponding student, a yellow lamp is switched, such that the ON-state yellow lamp is maintained until the student answers the caution- or call-signal. The above-mentioned example of the lecture-information display 38 will be described later, and it should be noted that the scope of the lecture-information display 38 is not limited to only the above-mentioned example, and can be modified in various ways as necessary.

If the student has a question during the lecture and selects the question button contained in the lecture-participation button unit 37, the terminal controller 32 wirelessly transmits corresponding question information via the RF module 33 and the antenna 34, such that the corresponding question information is received in the lecture repeater 40. Thereafter, the corresponding question information is transmitted to the lecturer-seat terminal 50 of the lecturer via the lecture repeater 40. Therefore, the occurrence of the corresponding question information is displayed on the lecturer-seat terminal 50, such that the lecturer can recognize the occurrence of the question information. The above-mentioned situation that the question information is received in the lecturer-seat terminal is notified to the student-seat terminal 30, and is displayed on the lecture-information display 38. As a result, the student of the question information recognizes that his or her question has been received by the lecturer and waits for the response to the question.

In this case, the above-mentioned question information includes student information and student-seat information retrieved from the student card.

If the lecturer gives his or her students the quiz, the terminal controller 32 receives specific information indicating the quiz has occurred from the lecturer-seat terminal 50, and displays the quiz on the lecture-information display 38. The above-mentioned situation that the quiz of the lecturer has been displayed on the lecture-information display 38 is continuously maintained until a corresponding student answers the quiz, and may force the student to answer the quiz.

Upon receiving the quiz from the lecturer, the corresponding student selectively presses the response button of the lecture-participation button unit 37 to answer the quiz, the terminal controller 32 wirelessly transmits quiz response information of the student to the lecturer-seat terminal 50, and quiz-marking information is also displayed on the lecture-information display 38.

Indeed, the lecturer gives the student the quiz via his or her voice or an additional presentation tool, such that the lecturer can invite the student to answer the quiz by selecting a desired answer from among a few exemplary answers recommended by the lecturer. Therefore, the student presses the response button of the lecture-participation button unit 37 to answer the quiz. In this case, the above response button may be composed of simple number buttons.

The memory unit 35 stores simple setup information and device status information. The battery 36 provides the student-seat terminal 30 with a power-supply signal.

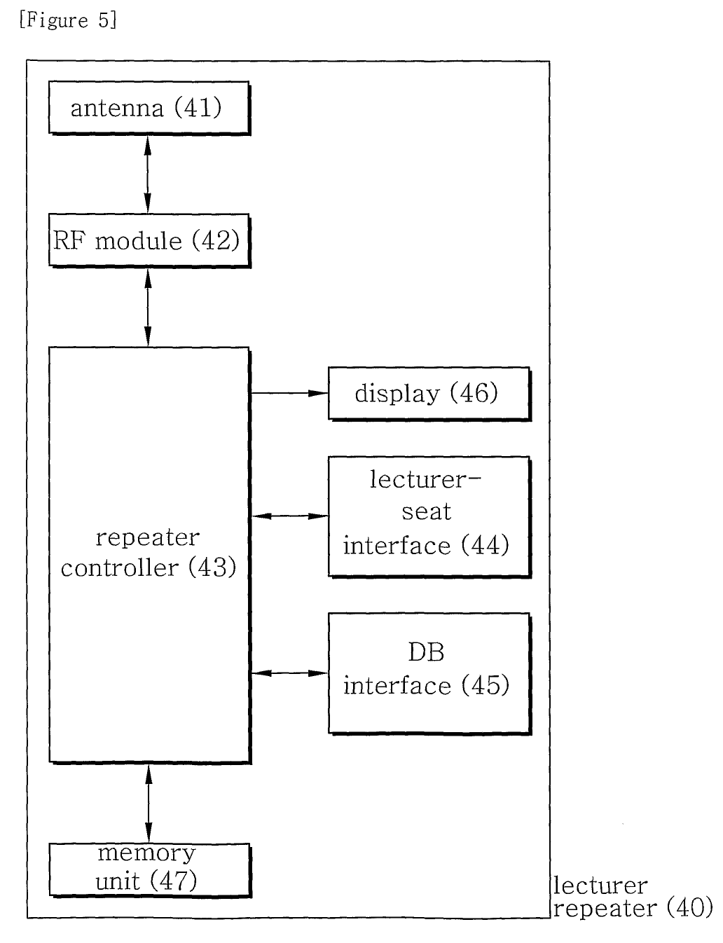

In the meantime, the lecture repeater 40 wirelessly communicates with the student-seat terminal 30, and communicates with the student-seat terminal and the lecture-support server by wire. As shown in FIG. 5, the lecture repeater 40 includes an antenna 41, an RF module 42, a repeater controller 43, a display 46, a student-seat interface 44, a DB interface 45, and a memory unit 47.

The antenna 41 and the RF module 42 wirelessly receive attendance information, question information, quiz-response information, and lecture-understanding-degree information from the student-seat terminal 30, and wirelessly transmit attendance-confirmation information, question-receipt information, marking information (i.e., grade information), and lecture-understanding-degree submission information to the student-seat terminal 30, such that the antenna 41 and the RF module 42 exchange a variety of information with the student-seat terminal 30 or an external part.

In addition, the lecturer-seat interface 44 is connected to the student-seat terminal 30 by wire, such that it communicates with the student-seat terminal 30. The DB interface 45 is connected to the lecture-support server 60 by wire, such that it communicates with the lecture-support server 60.

In other words, the lecture repeater 40 configures a wireless-information switching interface along with the student-seat terminal 30, and at the same time configures a wired-information switching interface along with the lecturer-seat terminal 50 and the lecture-support server 60, such that it performs the switching of information communicated between the student-seat terminal 30 and the lecturer-seat terminal 50.

In this case, the lecturer-seat interface 44 is configured in the form of a USB interface, such that it is easily connected to the lecturer-seat terminal 50. The DB interface 45 communicates with the lecture-support server 60 via a TCP/IP protocol.

In the meantime, the lecturer-seat terminal 50 of the lecturer is connected to the lecture repeater 40, such that it can exchange information associated with the lecture progression with the student of the student-seat terminal 30. The lecturer-seat terminal 50 is connected to the lecture-support server 60, receives a variety of lecture support information from the lecture-support server 60, and reports the result of lecture progression to the lecture-support server 60.

In other words, the lecturer can recognize a variety of student information (e.g., current attendance status, student location in the lecture room, and basic information) supported by the lecture-support server 60 using the lecturer-seat terminal 50. Upon receiving the student's answer to the question or quiz of the lecturer, the lecturer directly recognizes the degree of lecture-participation of the student, and reports the lecture-participation degree to the lecture-support server 60, such that the lecture-support server 60 may use the report to evaluate the student's achievement in the future.

The lecturer-seat terminal 50 transmits or receives information associated with the lecture progression to/from the student-seat terminal 30 via the lecture repeater 40. The lecturer-seat terminal 50 gains access to the lecture-support server 50, receives a variety of lecture-support information including student's attendance information supported by the lecture-support server 50, and reports the lecture-progression result to the lecture-support server 60. The student-seat terminal 30 acting as a computer includes an Internet browser capable of displaying Web-contents. The student-seat terminal 30 may include personal computers (e.g., a desktop computer and a notebook computer), mobile phones, PDAs (Personal Digital Assistants), IMT2000 phones, and wired phones, etc. The student-seat terminal 30 may further include a display (not shown), a CPU of at least Pentium-grade, a data storage unit, a memory of at least 64 MB, and an OS (Operating System) of at least Windows 98.

In other words, if the lecture begins, the lecture-support server 60 performs attendance registration, and transmits lecture-progression information to the student-seat terminal 30, such that a corresponding lecturer can recognize information of all the students of the lecture room via the lecturer-seat terminal 50.

In this way, the lecture-progression information transmitted from the lecture-support server 60 to the lecturer-seat terminal 50 includes a variety of student information of a current attendant, for example, name, photo-image, and current student-seat information of the current attendant. Therefore, the lecturer can recognize information of all the students, i.e., names, faces, and current seat locations of the students. Furthermore, the above-mentioned lecture-progression information further includes a department, a student number, attendance information, lecture-participation status, and question-participation status of the current attendant, such that the lecturer can also recognize detailed information of the students who participate in the lecture.

In this case, the lecture-progression information transmitted from the lecture-support server 60 to the lecturer-seat terminal 50 may include not only attendance information of the attendant students but also information of absent students.

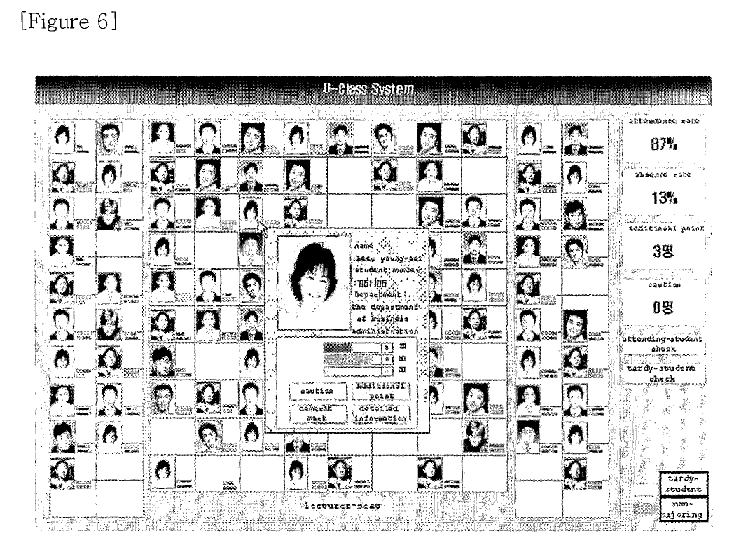

The above-mentioned lecture-progression information may configure a main screen image capable of inviting the lecturer-seat terminal 60 to recognize a situation of the lecture room, and an example of the main image is depicted in FIG. 6.

Referring to FIG. 6, the lecturer-seat terminal 50 receives student-attendance situations, student-seat location, and basic information of the students from the lecturer-support server 60, and displays the received information thereon, such that the lecturer can easily recognize situations of all the students of the lecture room during the lecture.

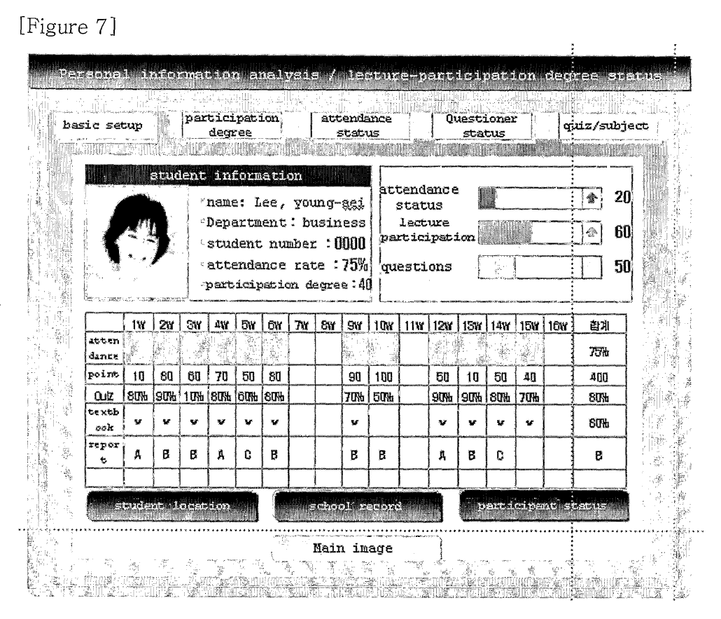

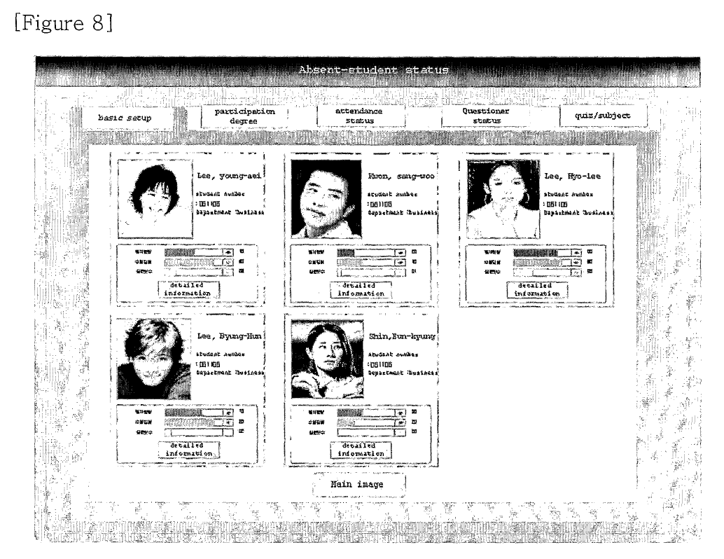

The lecturer selects a single student from among several students on the main image of FIG. 6, and recognizes detailed information of the selected student, for example, name, department, student number, attendance status, lecture participation degree, the number of questions, and attitude of the selected student, etc., as depicted in FIG. 7. The lecturer selects a specific menu for checking an absent student on the main image, and confirms the absent student as shown in FIG. 8.

Student's detailed information displayed on the lecturer-seat terminal 50 is received from the lecture-support server 60.

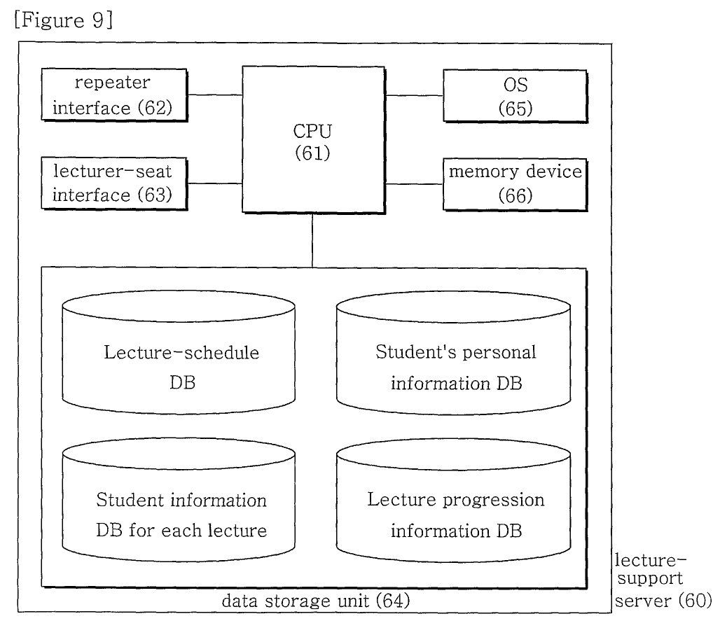

In the meantime, as shown in FIG. 9, the lecture-support server 60 for supporting the lecturer-seat terminal 50 includes a CPU 61, a repeater interface 62, a lecturer-seat interface 63, a data storage unit 64, an additional OS 65, a memory unit 66 including a RAM and a ROM, and a display (not shown).

The CPU 61 must perform a large number of mathematical calculations and must inspect databases (DBs) in order to conduct a large number of tasks and mutual-information communication. Preferably, the CPU 61 may be either one of a 100 MHz P54C CPU of Intel Corporation, a 120 MHz Power-PC604 CPU of Motorola Corporation, and a 166 MHz Ultra-SPARC-1 based CPU of Sun Micro system. In this case, the 100 MHz P54C CPU of Intel Corporation, the 120 MHz Power-PC604 CPU of Motorola Corporation, and the 166 MHz Ultra-SPARC-1 based CPU are driven by different operating systems (OSs).

The memory unit 66 is designed to temporarily store data therein, and may be a memory of at least 128 MB.

The repeater interface 62 and the lecturer-seat interface 63 support a connection between the lecture repeater 40 and the lecturer-seat terminal 50.

The data storage unit 64 includes a variety of DBs, i.e., a lecture-schedule DB, a student's personal information DB, a student information DB for each lecture, a lecture progression information DB, and a estimation information DB for each student. Generally, the data storage unit 64 generates/manages the above-mentioned DBs using a DB management software program such as the Oracle Data Software manufactured by Oracle Corporation.

The schedule information DB stores a variety of lecture information of several lecture rooms, for example, lecture-time information, lecturer information, lecture-room number information, lecturer's log-in information, etc. In this case, the above-mentioned lecture information of several lecture rooms are managed by the lecture-support server. However, it should be noted that the lecture information is not limited to the above-mentioned exemplary information, and can also be applied to other information as necessary.

The student's personal information DB includes a variety of information of each student, for example, name, resident registration number, student number, photo-image, address, phone number, and grade of the student. However, it should be noted that the student's personal information is not limited to the above-mentioned exemplary information, and can also be applied to other information as necessary.

The student information DB for each lecture includes a variety of student information for each lecture, for example, a fixed-student number of the lecture, the number of students of the lecture, the number of student's lecture participations, a student's attendance situation, and a lecturer, etc. However, it should be noted that the student information is not limited to the above-mentioned exemplary information, and can also be applied to other information as necessary.

The lecture progression information DB includes question-status information (e.g., questioner, the number of questions, and a question time) generated during the lecture time, quiz-status information (e.g., a quiz respondent and quiz-marking result), student-attitude estimation information (e.g., the presence or absence of textbook, the submission of homework, and learning-attitude estimation result), and lecture-understanding information of each student. However, it should be noted that the lecture progression information is not limited to the above-mentioned exemplary information, and can also be applied to other information as necessary.

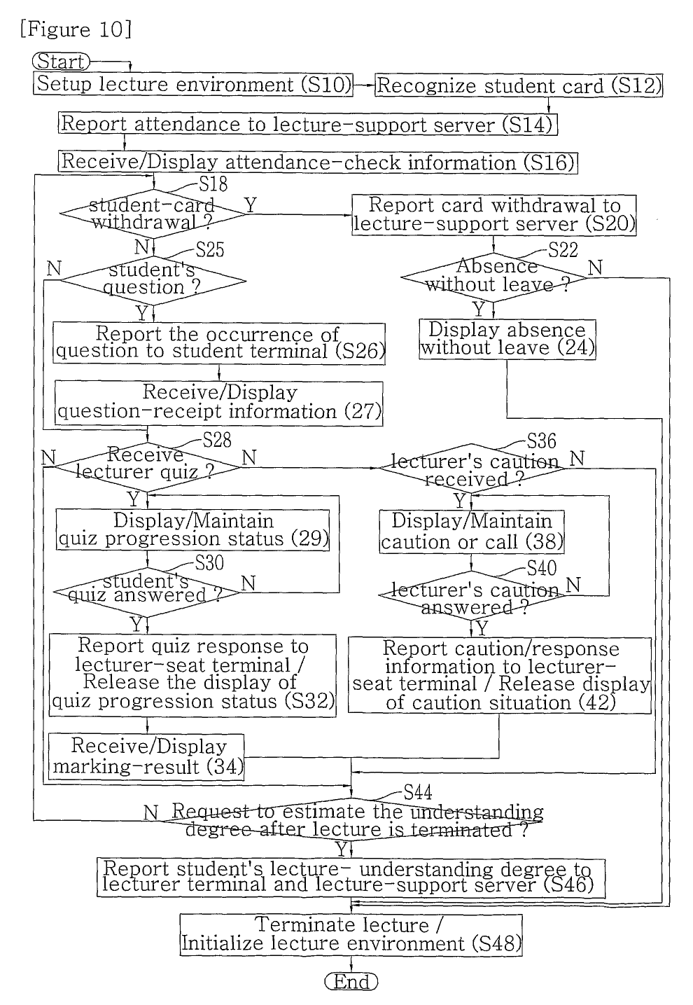

FIG. 10 is a flow chart illustrating a method for supporting a two-way lecture suitable for the Ubiquitous educational environment according to a first preferred embodiment of the present invention.

Referring to FIG. 10, if the student-seat terminal 30 recognizes the student card 20, it registers attendance of the student who carries the student card 20 in the lecture-support server 60. If the student has a question during the lecture, the student-seat terminal 30 informs the lecturer-seat terminal 50 of the question. If the lecturer gives the student the quiz, the student-seat terminal 30 transmits the student's answer to the quiz to the lecturer-seat terminal 50, thereby facilitating the lecture progression of the lecturer. Also, the student-seat terminal 30 makes a guarantee of the student participation in the lecture, such that the quality of the lecture increases.

The terminal controller 32 of the student-seat terminal 30 wirelessly receives a lecture-beginning signal from the lecture-support server 60 through the medium of the lecture repeater 40 via the antenna 34, and activates functions of the corresponding student-seat terminal 30 at step S10.

Thereafter, the terminal controller 32 reads student information of the student card 20 from the card reader 31, such that it primarily recognizes the attendance of a corresponding student on the basis of the read student information at step S12. In this case, the corresponding student inserts the student card 20 into the card reader 31 or brings the student card 20 into contact with the card reader 31.

In this case, the student information of the student card 20 may include at least one of name, student number, resident registration number, and card number of the corresponding student. Preferably, the student information of the student card 20 may be a student identity (ID) code capable of identifying the corresponding student. The student information of the student card is stored in the memory unit 35 of the student-seat terminal 30, such that it is maintained during the lecture time.

The terminal controller 32 wirelessly transmits student's attendance information, including student information having been read at step S12 and installation location of the student-seat terminal, to the lecture repeater 40, such that it transmits corresponding student's attendance information to the lecture repeater 40, and transmits the corresponding attendance information to the lecture-support server 60 via the lecture repeater 40, thereby performing the attendance-reporting step at step S14.

The student-seat terminal 30's attendance information received in the lecture-support server 60 is registered in the lecture-information DB of the lecture-support server 60 along with its time information, such that it authenticates student's attendance of the corresponding student-seat terminal 30. Therefore, the attendance confirmation information indicating the completion of the student's attendance authentication of the lecture-support server 60 is transmitted to the student-seat terminal 30.

The terminal controller 32 recognizes attendance-confirmation information of the lecture-support server 60 via the lecture repeater 40, and displays attendance-authentication confirmation information indicating the completion of the attendance confirmation of the corresponding student on the lecture-information display 38 at step S16.

After checking the presence or absence of the corresponding student as described above, the terminal controller 32 of the student-seat terminal 30 determines whether the card reader 31 recognizes the student card 20 of the corresponding student at step S18. In other words, the terminal controller 32 determines whether a card withdrawal signal generated when the student card is withdrawn is received from the card reader 31 at step S18.

If it is determined that the student card is withdrawn at step S18, the terminal controller 32 wirelessly transmits the card-withdrawal information to the lecture repeater 40, and transmits corresponding card-withdrawal information to the lecture-support server 60 through the medium of the lecture repeater 40, in such a way that the card withdrawal report step is executed at step S20.

The student-seat terminal 30 stores student information of a corresponding student card in the memory unit 35 on the condition that the student card has been inserted into the student-seat terminal 30, reads the student information from the corresponding student card at intervals of a predetermined time, and compares the read student information with specific information stored in the memory unit 35, such that it can determine whether the corresponding student-seat terminal is withdrawn or not.

Upon receipt of the above-mentioned card withdrawal report, the lecture-support server 60 determines whether a corresponding lecture is terminated due to the occurrence of inevitable reasons, instead of a prescribed termination time, by referring to the intermediate-termination report of the lecturer-seat terminal 50. If it is determined that the corresponding lecture is terminated due to the occurrence of the inevitable reasons, the lecture-support server 60 informs the student-seat terminal 30 of the lecture termination. If it is determined that the corresponding lecture is terminated due to other reasons other than the inevitable reasons, the lecture-support server 60 informs the student-seat terminal 30 and the lecturer-seat terminal 50 that the corresponding student has left the lecture room without notice to the lecturer.

Therefore, upon receiving the report indicating the corresponding card has been withdrawn, the student-seat terminal 30 determines whether the corresponding student leaves the lecture room without notice to the lecturer upon receiving the result information from the lecture-support server 60 at step S22. If it is determined that the student leaves the lecture room without notice to the lecturer, the student-seat terminal 30 displays specific information, indicating that the corresponding student has left the lecture room without notice to the lecturer, on the lecture-information display 38 at step S24. For example, the above-mentioned situation that the corresponding student has left the lecture room without notice may be displayed on the lecture-information display 38 by blinking a red lamp several times.

In the meantime, if it is determined that the student card is not withdrawn at step S18, the terminal controller 32 determines whether the student's question is visually displayed on the lecture-participation button unit 37 during the lecture at step S25.

If it is determined that the student's question has occurred at step S25, the terminal controller 32 wirelessly transmits question information to the lecture repeater 40, such that the corresponding question information, which includes student information and student-seat information of the corresponding student, is transmitted to the lecturer-seat terminal 50 via the lecture repeater 40, thereby performing a question occurrence report at step S26.

The question occurrence status of the student-seat terminal 30 is transmitted to the lecturer-seat terminal 50, and is displayed on the display of the lecturer-seat terminal 50 along with the student's location and the student's photo-image. The corresponding lecturer-seat terminal 50 informs the student-seat terminal 30 of the acceptance of the corresponding question. The corresponding lecturer completes an explanation of the lecture, confirms the receipt of the question displayed on the display, listens to question contents of the student who has the question, and answers the question of the student.

The terminal controller 32 wirelessly recognizes question-receipt information of the lecturer-seat terminal 50 via the lecture repeater 40, and displays a question-receipt confirmation message, indicating that the student's question has been received by the corresponding lecturer, on the lecture-information display 38 at step S27. For example, the question-receipt confirmation message may be visually indicated by switching on a green lamp at step S27.

Therefore, the student may inform the lecturer of his or her question without breaking the flow of the lecture during the lecture using the student-seat terminal 30. The lecturer completes his or her explanation without interruption, checks the occurrence of the student's question via the lecturer-seat terminal 50, and receives personal information of the students from the lecture-support server 60, such that the lecture can immediately recognize detailed information (e.g., current student's seat, photo-image of the student who has the question, attendance status of the student, lecture-participation degree of the student, and the number of questions of the student) of the corresponding student who has the question using the lecture-support server 60, thereby facilitating the lecture flow and increasing the ties between the lecturer and the student.

In the meantime, if the lecturer gives the students the quiz, the terminal controller 32 determines whether specific information indicating the occurrence of the quiz is received via the lecture repeater 40 at step S28.

In this case, the lecturer's quiz is generated by the lecturer's speech. The quiz-occurrence information indicates that the corresponding lecturer gives the students the quiz, such that it may be notified to the lecturer-seat terminal 50 as necessary.

If the lecturer's quiz occurs at step S28, the terminal controller 32 wirelessly recognizes the quiz-occurrence information of the lecturer-seat terminal 50 via the lecture repeater 40, and visually displays quiz-progression information indicating that the lecturer has given the students the quiz on the lecture-information display 38 at step S29. For example, the quiz-progression information may be visually indicated by switching on the red lamp.

In this case, the quiz-occurrence information is transmitted to several student seats, such that it may request a plurality of students to answer the quiz. Upon receiving the quiz-occurrence information, quiz-progression information (e.g., ON-state red lamp) displayed on the lecture-information display 38 is maintained until the student answers the quiz, such that the lecturer may force the corresponding student to answer the quiz.

The above-mentioned quiz invites the student to select a single answer from among several exemplary answers recommended by the lecturer. The student presses a response button corresponding to his or her desired number using the lecture-participation button unit 37, such that the student can answer the quiz.

Thereafter, the terminal controller 32 determines whether a quiz-response signal of the corresponding student is received via the response button of the lecture-participation button unit 30, such that it determines whether the corresponding student answers the quiz at step S30.

If it is determined that the student answers the quiz at step S30, the terminal controller 32 wirelessly transmits student-seat information and quiz-response information to the lecture repeater 40, transmits corresponding quiz-response information to the lecturer-seat terminal 50 via the lecture repeater 40, and at the same time releases or cancels the indication of quiz-progression information displayed on the lecture-information display 38 at step S32. In this case, the student-seat information includes student information of a corresponding student and an installation location of the corresponding student-seat terminal, and the quiz-response information includes response-number information of the corresponding student.

Therefore, the students responses to the quiz are transmitted to the lecturer-seat terminal 50. If the lecturer enters a correct answer in the lecturer-seat terminal 50, correct-answer students and wrong-answer students are distinguished from each other. The lecturer-seat terminal 50 transmits the quiz-marking result indicating the correct- or wrong-answer to the individual student-seat terminals 30 which have answered the quiz.

Therefore, the terminal controller 32 of the lecturer-seat terminal 50 wirelessly receives the quiz-marking result information received from the lecturer-seat terminal 50 via the lecture repeater 40, such that it recognizes the quiz-marking result. In addition, the terminal controller 32 visually indicates whether the answer of the corresponding student is correct on the lecture-information display at step S34, such that the corresponding student may recognize whether his or her answer is correct. For example, if the student's answer is correct, the terminal controller 32 may turn on the green lamp. Otherwise, if the student's answer is wrong, the terminal controller 32 may turn on the red lamp.

If the lecturer desires to give unfaithful students, who have unfaithful attitudes, warning messages (i.e., caution messages) or desires to call a specific student, the terminal controller 32 determines whether warning- or call-message information generated from the lecturer-seat terminal 50 is received via the lecture repeater 40 at step S36.

In this case, the warning or caution message of the lecturer is assigned to specific students who have unfaithful or careless attitudes from among several students displayed on the lecturer-seat terminal 50. Even when the lecturer desires to call a specific student from among several students, the call message of the lecturer may also be received from the lecturer-seat terminal via the lecture repeater 40 in the same manner as in the aforementioned case.

If the lecturer generates the warning message or the call message at step S36, the terminal controller 32 recognizes that the warning- or call-message has been generated from the lecturer-seat terminal 50 via the lecturer repeater 40, and displays specific information indicating the warning- or call-message progression on the lecture-information display 38 at step S38. For example, the warning- or call-message progression status may be indicated by switching on the yellow lamp.

In this case, upon receiving the warning- or call-message information (i.e., reception of a caution- or call-message of the lecturer), the caution- or call-progression message displayed on the lecture-information display 38 is maintained until the student answers the warning- or call-message of the lecturer, such that the lecturer can force the student to answer the warning- or call-message.

If the warning- or call-message occurs, the corresponding student presses a response button of the lecture-participation button unit 37 to inform the lecturer of the recognition of the warning- or call-message.

Thereafter, the terminal controller 32 receives specific information indicating reception of the student's answer to the warning- or call-signal via the response button of the lecture-participation button unit 30, such that it determines whether the corresponding student has answered the warning- or call-signal of the lecturer at step S40.

If it is determined that the student answers the warning- or call-signal of the lecturer at step S40, the terminal controller 32 wirelessly transmits the student's response information of the warning- or call-message of the lecturer to the lecture repeater 40. In this case, the student's response information includes student information and student-seat information indicating the installation location of the corresponding student-seat terminal. Therefore, the student's response information of the warning- or call-message is transmitted to the lecturer-seat terminal 50 via the lecture repeater 40, and at the same time the warning- or call-progression information displayed on the lecture-information display 38 is released or cancelled at step S42.

Therefore, if the corresponding student answers the warning- or call-message of the lecturer using the student-seat terminal 30, the lecturer can recognize whether the student has correctly received the warning- or call-message, and the student can correctly recognize the warning- or call-message of the lecturer such that the student can answer the warning- or call-message.

In the meantime, if a current time approaches a predetermined lecture termination time, the terminal controller 32 determines whether lecture-understanding-estimation request information is received from the lecturer-seat terminal 50 via the lecture repeater 40 at step S44.

If the lecture-understanding-estimation request is generated from the lecturer at step S44, the terminal controller 32 wirelessly receives the lecture-understanding-estimation request information of the lecturer-seat terminal 50 via the lecture repeater 40, and recognizes the received lecture-understanding-estimation request information. The terminal controller 32 informs the corresponding student of the lecture-understanding-estimation request information using the lecture-information display 38. The terminal controller 32 wirelessly transmits lecture-understanding report information to the lecture repeater 40, such that the lecture-understanding report information of the corresponding student is transmitted to the lecturer-seat terminal 50 and the lecture-support server 60 at step S46. In this case, the lecture-understanding report information includes student information, student-seat information indicating the installation location of the corresponding student-seat terminal, and lecture-understanding level-number information of the student.

In this case, as described above, the lecture-understanding report information is simultaneously notified to the lecturer-seat terminal 50 and the lecture-support server 60, and is then stored in the lecturer-seat terminal 50 and the lecture-support server 60. Therefore, based on the lecture-understanding report information, the lecture-support server 60 can recognize who the lecturer is, and configures the lecture-understanding information in the form of a database (DB), such that the configured DB may be used as reference data or lecture-schedule data of the lecture in the future.

Thereafter, the terminal controller 32 wirelessly receives the lecture termination signal from the lecturer-seat terminal 50 or the lecture-support server 60, and initializes functions of the student-seat terminal 30 at step S48.

The above-mentioned initialization of the student-seat terminal 30 is performed whenever the lecture is terminated, such that the student-seat terminal 30 waits for the next lecture.

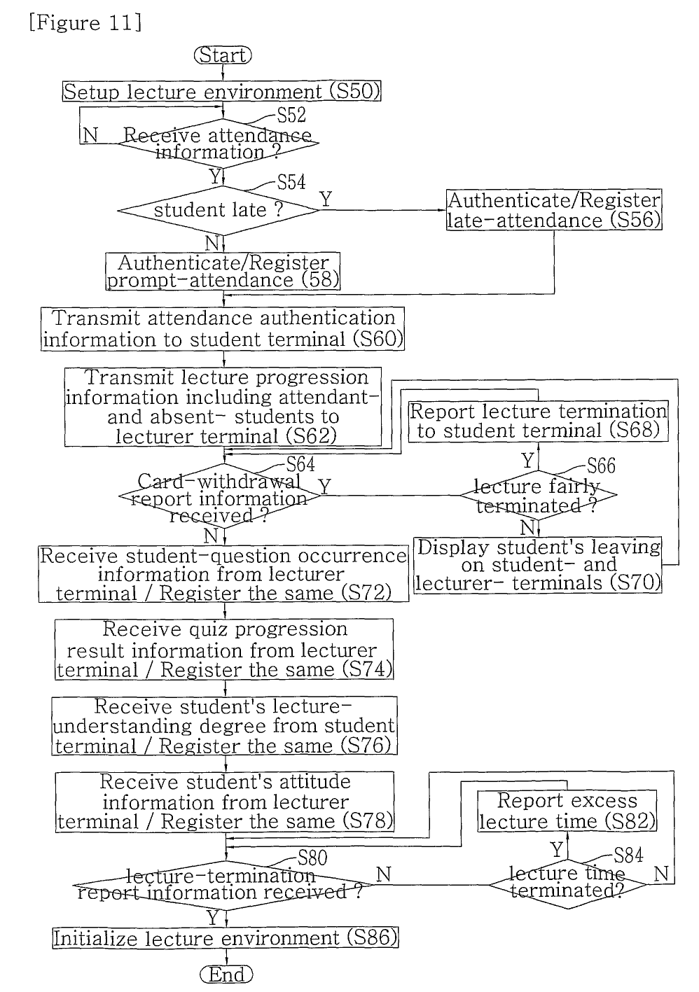

FIG. 11 is a flow chart illustrating a method for supporting a two-way lecture suitable for the Ubiquitous educational environment according to a second preferred embodiment of the present invention.

Referring to FIG. 11, the lecture-support server 60 receives attendance information from at least one student-seat terminal 30, and performs attendance registration/authentication of a corresponding student. If the lecture begins, the lecture-support server 60 transmits lecture-progression information to the lecturer-seat terminal 50 to facilitate the lecture progression. In this case, the lecture-progression information includes attendant-student information and absent-student information of the lecture. The lecture-support server 60 receives information of all the situations (e.g., student's question, lecturer's quiz, and lecture-understanding-estimation information) of a corresponding lecture room, and configures the received information in the form of a DB. As a result, the lecture-support server 60 helps the lecturer to progress the lecture, records lecture-participation information of the student, and reflects the recorded lecture-participation information in the student's grade or the lecture-reference data, such that the quality of the lecture is improved.

The CPU 61 of the lecture-support server 60 outputs a lecture-beginning signal indicating the beginning of the lecture via the repeater interface 62 and the lecturer-seat interface 63, and transmits the lecture-beginning signal to the student-seat terminal 30 and the lecturer-seat terminal 50 of the lecture room, such that the lecture-room environment is activated at step S50.

Thereafter, the CPU 61 determines whether the student's attendance information from the student-seat terminal 30 has been wirelessly received from the student-seat terminal via the lecture repeater 40 at step S52.

In this case, the received student's attendance information includes not only student-seat information indicating the installation location of the corresponding student-seat terminal, but also information of the student who has sat on the student-seat terminal. The above-mentioned student information includes at least one of a name, a student number, a resident registration number, and a card number of the student.

Upon receiving the student's attendance information from the student-seat terminal 30 at step S52, the CPU 61 extracts lecture-beginning tie information from the lecture-schedule DB contained in the data storage unit 64, compares the extracted lecture-beginning time information with the reception time of the student's attendance information, and determines whether the corresponding student was late for the lecture at step S54.

If it is determined that the received student's attendance information indicates that the corresponding student was late for the lecture at step S54, the CPU 61 authenticates that the student was late for the lecture, and registers the authentication information in a corresponding student's allocation area contained in the student information DB of the data storage unit 64 at step S56.

In the meantime, if the received student's attendance information indicates that the student has not arrived late at step S54, the CPU 61 authenticates that the above-mentioned student's attendance information indicates student's prompt attendance, and registers the authenticated information in the corresponding student's allocation area of the student information DB contained in the data storage unit 64 at step S58.

Therefore, the CPU 61 of the lecture-support server 60 outputs the attendance-confirmation information acquired by the authentication result of the above-mentioned student's attendance information to the lecture repeater 40 together with target student-seat terminal information. The corresponding authentication result is transmitted to the student-seat terminal 30, and is displayed on the lecture-information display 38 of the student-seat terminal 30 at step S60. In this case, the above-mentioned authentication result may be visually displayed on the lecture-information display 38 by blinking the green lamp several times.

Therefore, the CPU 61 retrieves the lecture-progression information from the data storage unit 64 at the beginning time of the lecture, and transmits the retrieved lecture-progression information to the lecturer-seat terminal 50 at step S62. In this case, the lecture-progression information may include the current attendant- or absent-student situation result.

In this case, if the tardy student shows up later, the lecture-progression information at step S62 is updated, such that the updated lecture-progression information is continuously provided to the corresponding lecturer-seat terminal 50.

In this case, as shown in FIGS. 6˜8, the lecture-progression information transmitted from the lecture-support server 60 to the lecturer-seat terminal 50 at the beginning time of the lecture, includes a variety of student information of a current attendant, for example, name, photo-image, and current student-seat information of the current attendant. Therefore, the lecturer can recognize information of all the students, i.e., names, faces, and current seat locations of the students. Furthermore, the above-mentioned lecture-progression information further includes a department, a student number, attendance information, lecture-participation status, and question-participation status of the current attendant, such that the lecturer can also recognize detailed information of the students who participate in the lecture. Preferably, the lecture-progression information transmitted from the lecture-support server 60 to the lecturer-seat terminal 50 may include not only attendance information of the attendant students but also information of absent students.

Thereafter, the CPU 61 of the lecture-support server 60 determines whether the card-withdrawal signal generated when the student card is separated from a specific student-seat terminal 30 is received via the lecture repeater 40 at step S64.

If the card-withdrawal signal is received from the specific student-seat terminal 30 at step S64, the CPU 61 determines the presence or absence of the intermediate-termination report of the lecturer-seat terminal 50, such that it determines a corresponding lecture is terminated due to the occurrence of inevitable reasons, instead of a prescribed termination time, by referring to the intermediate-termination report of the lecturer-seat terminal 50 at step S66.

If it is determined that the corresponding lecture is terminated due to the occurrence of the inevitable reasons at step S66, the lecture-support server 60 informs the student-seat terminal 30 of the lecture termination at step S68.

If it is determined that the corresponding lecture is terminated due to other reasons other than the inevitable reasons at step S66, the lecture-support server 60 informs the student-seat terminal 30 and the lecturer-seat terminal 50 that the corresponding student has left the lecture room without notice to the lecturer, by blinking the red lamp several times, and at the same time a predetermined message of the lecturer-seat terminal 50 of the lecturer occurs, such that the lecturer can recognize that the student has left the lecture room without notice by referring to the predetermined message at step S70.

In the meantime, if the student transmits a question to the lecturer-seat terminal 50 via the student-seat terminal 30 during the lecture, the CPU 61 receives question-occurrence report information from the lecturer-seat terminal 50, and stores the question-occurrence report information in the lecture-progression information DB of the data storage unit 64, such that it may use the stored information to manage the student's grade at step S72.

In this case, the above-mentioned question-occurrence report information includes student information of the corresponding student who has the question and student-seat information indicating the installation location of the student-seat terminal. Preferably, the question-occurrence report information may include a simple estimation score or comment recorded by the lecturer who has heard the student's question.

Next, if the lecturer-seat terminal 50 transmits the quiz to at least one student-seat terminal 30 during the lecture time, the CPU 61 receives quiz-progression result report information, including the quiz information and quiz-marking information of the student who has answered the quiz, from the lecturer-seat terminal 50, and stores the quiz-progression result report information in the lecture-progression information DB of the data storage unit 64, such that it may use the stored information to manage the student's grade at step S74.

In this case, the quiz-progression result report information includes contents of the quiz, student information of the student who has answered the quiz, and student's marking information.

Next, provided that the lecturer estimates the degree of the lecture-understanding of each student using the lecturer-seat terminal 50 after receiving the student's answer from the student-seat terminal 30, the CPU 61 receives the lecture-understanding estimation information of the student from the student-seat terminal 30 or the lecturer-seat terminal 50, and stores the lecture-understanding estimation information of the student in the lecture-progression information DB of the data storage unit 64, such that it may use the stored information as lecture-reference documents of the lecture at step S76.

If a current time approaches a predetermined lecture termination time, the CPU 61 receives student-attitude report information from the lecturer-seat terminal 50, and stores the student-attitude report information in the lecture-progression information DB of the data storage unit 64, such that it may use the stored information to manage the student's grade at step S78.

In this case, the above-mentioned student-attitude report information may include a variety of student-attitude information (e.g., the presence or absence of textbook, the submission of homework, and learning-attitude estimation result).

In other words, the lecture-understanding estimation action for each student at step S76 and the student-attitude report action at step S78 are not limited to only the lecture termination time, and can also be freely executed by the lecturer during the lecture time, such that lecture-understanding estimation information and the student-attitude report information are notified to the lecture-support server 60 via the lecturer-seat terminal 50.

Thereafter, the CPU 61 determines whether the lecturer-seat terminal 50 has reported the lecture termination at step S80. If it is determined that the lecturer-seat terminal 50 has not reported the lecture termination at step S80, the CPU 61 determines whether a predetermined lecture termination time elapses by referring to the lecture schedule at step S82. If it is determined that the corresponding lecture is continued after the lapse of the lecture termination time, the CPU 61 informs the lecturer-seat terminal 50 of the occurrence of overtime at step S84.

In this case, the CPU 61 informs each student-seat terminal 30 of the occurrence of overtime, displays specific information indicating the occurrence of overtime on the student-seat terminal 30, such that students can also recognize the occurrence of overtime during the lecture.

In the meantime, upon receiving the lecture termination information from the lecturer-seat terminal 50 at step S80, the CPU 61 transmits a signal indicating the lecture termination to the lecturer-seat terminal 50 and the student-seat terminal 30, and initializes functions of the lecturer-seat terminal 50 and the student-seat terminal 30 at step S86. The above-mentioned lecture-room initialization is performed whenever the lecture is terminated, such that the student-seat terminal 30 waits for the next lecture.

Although the above-mentioned preferred embodiments have limited the application place of the present invention to only the lecture room in which the lecturer and the students are contained, it should be noted that the application place of the present invention can also be set to other places, for example, conference rooms, seminar room, and discussion rooms, etc.

### INDUSTRIAL APPLICABILITY

As apparent from the above description, a system and method for supporting a two-way lecture (also called a bi-directional lecture) suitable for the Ubiquitous educational environment according to the present invention control the lecture-support server to automatically recognize the presence or absence of at least one student via wireless terminals installed at individual student-seats of a lecture room, prevent a proxy attendance from being generated, and prevent the beginning time of a lecture from being delayed due to the occurrence of wasted time.

The system according to the present invention monitors the presence or absence of fraudulent behavior of the student during the lecture, and registers/manages the fraudulent behavior of the student who has left the lecture room without notice to the lecturer, such that it can prevent the student from leaving the lecture room after the student has registered his or her attendance, differently from the conventional student's attendance management system.

The system refers to lecture-progression information transmitted from the lecture-support server to the lecturer-seat terminal at the beginning time of the lecture, and the lecturer of the lecture room can recognize information of all the students, i.e., names, faces, and current seat locations of the students. Furthermore, the above-mentioned lecture-progression information further includes a department, a student number, attendance information, lecture-participation status, and question-participation status of the current attendant, such that the lecturer can also recognize detailed information of the students who participate in the lecture, resulting in the implementation of a systemized lecture suitable for a large-sized lecture room. There is no need to divide a large-scale lecture into a plurality of small-scale lectures, such that the system solves dissatisfaction between the lecturer and the students during a large-scale lecture, resulting in the reduction of management costs and personnel expenses.

The system according to the present invention allows each student-seat terminal to transmit a question to the lecturer-seat terminal, and allows the lecturer-seat terminal to receive the question from the student-seat terminal, such that the student can inform the lecturer of his or her question without breaking the flow of the lecture during the lecture using the student-seat terminal of the student. The lecturer completes his or her explanation without interruption, checks the occurrence of the student's question via the lecturer-seat terminal, and answers the question, thereby facilitating the flow of the lecture. The system according to the present invention invites the lecturer-seat terminal to automatically generate the quiz during the lecture, allows the lecturer-seat terminal to automatically mark the student's answer to the quiz, can naturally give the student the warning- or call-signal, and can easily recognize the degree of lecture-understanding information of each student after the lecture is terminated, such that it can naturally proceed the lecture, and educational matters and learning management can be facilitated.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

1. A system for supporting a two-way lecture suitable for Ubiquitous educational environments comprising:
a wireless-type student-seat terminal which is installed at each student-seat of a lecture room, reads student information from a student card of a student who has sat on the student-seat, wirelessly transmits attendance information including the student information and student-seat information to an external part, wirelessly receives attendance-authentication confirmation information, and displays attendance status information on a lecture-information display;
a lecture repeater for switching data communication between the student-seat terminal and an external wired device;
a lecture-support server for receiving the attendance information from the student-seat terminal via the lecture repeater, registering the attendance information to perform attendance authentication, transmitting the attendance-authentication confirmation information to the student-seat terminal via the lecture repeater, changing a current status of the student-seat terminal to an attendance status, including the attendance-authentication confirmation information in student's detailed information of the student-seat terminal of the lecture room, and storing the student's detailed information; and
a lecturer-seat terminal which is installed at each student-seat of the lecture room, reads attendance status information of each student-seat and detailed information of the student who has sat on the student-seat from the lecture-support server, allows a lecturer to recognize the attendance status information and the student's detailed information, and progresses the lecture by communicating with the student-seat terminal via the lecture repeater.

2. The system according to claim 1, wherein:
the student-seat terminal includes a card reader for reading the student information from the student card, and
if the student card is withdrawn from the card reader during the lecture, the student-seat terminal transmits card-withdrawal information including corresponding student information and student-seat information to the lecture-support server, and displays specific information indicating that the student has left the lecture room without notice or the lecture has been terminated on the lecture-information display.

3. The system according to claim 2, wherein:
the student-seat terminal includes a question button, and
if the student who has a question informs the lecturer of the question using a corresponding question button during the lecture, the student-seat terminal transmits question information including the corresponding student information and student-seat information to the lecturer-seat terminal in order to allow question status information to be received in the lecturer-seat terminal, and displays question-receipt status information on the lecture-information display.

4. The system according to claim 3, wherein:
the student-seat terminal includes a response button composed of at least one button, and
if quiz-occurrence information is transmitted from the lecturer-seat terminal to the student-seat terminal, the student-seat terminal indicates that the student is indicative of a quiz target using the lecture-information display, transmits quiz-response information of the student selected by the response button to the lecturer-seat terminal, and displays quiz-marking status information on the lecture-information display.

5. The system according to claim 5, wherein:
the student-seat terminal includes a response button composed of at least one button, and
if warning- or call-message information is received from the lecturer-seat terminal, the student-seat terminal indicates that the warning- or call-message information of the lecturer has been received using the lecture-information display, and transmits response information of the student who has recognized the warning- or call-message information to the lecturer-seat terminal using the response button.

6. The system according to claim 5, wherein:
the response button includes one or more buttons arranged in numerical order; and
the student-seat terminal invites the student to select a single response button from among the response buttons arranged in numerical order at a termination time of the lecture, configures student's selection information in the form of lecture-understanding estimation information of the lecture, and transmits the lecture-understanding estimation information to the lecturer-seat terminal and the lecture-support server.

7. The system according to claim 1, wherein the lecture-information display of the student-seat terminal includes light emitting diodes (LEDs), each of which has at least one color, such that status information of the student-seat terminal is indicated by different colors or blinking states of the LEDs.

8. The system according to claim 7, wherein the lecturer-seat terminal transmits lecture-progression result information associated with the student-seat terminal (i.e., student-question information, lecturer-quiz information, student-warning information, and lecture-understanding information for each student) to the lecture-support server, and stores the lecture-progression result information in the lecture-support server.

9. A method for supporting a two-way lecture suitable for Ubiquitous educational environments comprising:
a) reading, by a student-seat terminal installed at each student-seat of a lecture room, student information from a student card of a student who has sat on the student-seat, and wirelessly transmitting attendance information including the student information and student-seat information to an external lecture-support server;
b) wirelessly receiving, by the student-seat terminal, attendance-authentication confirmation information from the lecture-support server, and displaying attendance status information on a lecture-information display;
c) receiving, by the student-seat terminal, a question request from the student via a question button, wirelessly transmitting question information including corresponding student information and student-seat information to the lecturer-seat terminal in order to allow question status information to be received in the lecturer-seat terminal, and displaying question-receipt status information on the lecture-information display;
d) wirelessly receiving, by the student-seat terminal, quiz-occurrence information from the lecturer-seat terminal, indicating that the corresponding student is indicative of a quiz target using the lecture-information display, transmitting quiz-response information of the student selected by a response button to the lecturer-seat terminal, and displaying quiz-marking status information on the lecture-information display; and
e) inviting, by the student-seat terminal, the student to select a single response button from among response buttons arranged in numerical order at a termination time of the lecture, configuring student's selection information in the form of lecture-understanding estimation information of the lecture, and wirelessly transmitting the lecture-understanding estimation information to the lecturer-seat terminal and the lecture-support server.

10. The method according to claim 9, further comprising:
if a student card is withdrawn during the lecture, transmitting, by the student-seat terminal, card-withdrawal information including corresponding student information and student-seat information to the lecture-support server, and displaying specific information indicating that the student has left the lecture room without notice or the lecture has been terminated on the lecture-information display.

11. The method according to claim 10, further comprising:
wirelessly receiving, by the student-seat terminal, warning- or call-message information from the lecturer-seat terminal, indicating that the warning- or call-message information of the lecturer has been received using the lecture-information display, and transmitting response information of the student who has recognized the warning- or call-message information to the lecturer-seat terminal using the response button.

12. The method according to claim 11, further comprising:
wirelessly receiving, by the student-seat terminal, a lecture-termination signal from the lecturer-seat terminal or the lecture-support server, and initializing functions of the student-seat terminal to wait for a next lecture.

13. The method according to any claim 9, wherein the lecture-information display of the student-seat terminal indicates status information of the student-seat terminal using colors or blinking state of a light emitting diode (LED).

14. A method for supporting a two-way lecture suitable for Ubiquitous educational environments comprising:
a) receiving, by a lecture-support server, attendance information wirelessly transmitted from a student-seat terminal installed at each student-seat of a lecture room;
b) comparing, by the lecture-support server, a reception time of the attendance information with a lecture-beginning time, determining whether the attendance information indicates the occurrence of a tardy student, authenticating the attendance information as tardy attendance when the received attendance information indicates the occurrence of the tardy student, authenticating the attendance information as prompt attendance when the received attendance information does not indicate the tardy student, and storing the authenticated information;
c) transmitting, by the lecture-support server, attendance-confirmation information based on the attendance-information authentication result to the student-seat terminal, and changing a current status of the student-seat terminal to an attendance status;
d) extracting, by the lecture-support server, lecture-progression information including a current attendant- or absent-student situation result acquired by the attendance-authentication step at a lecture-beginning time, transmitting the extracted lecture-progression information to a lecturer-seat terminal, and allowing a lecturer to recognize detailed information of the attendant- or absent-student via the lecturer-seat terminal,
e) if the student-seat terminal transmits a student's question to the lecturer-seat terminal during the lecture in the lecture room, receiving, by the lecture-support server, question report information of the student from the lecturer-seat terminal, and storing the question report information;
f) if a quiz of the lecturer is transmitted from the lecturer-seat terminal to the student-seat terminal during the lecture in the lecture room, receiving quiz-progression result report information including the quiz and quiz-marking information of the student who has answered the quiz from the lecturer-seat terminal, and storing the quiz-progression result report information;
g) if the lecturer estimates the degree of the lecture-understanding of each student using the lecturer-seat terminal after receiving a student's answer from the student-seat terminal during the lecture in the lecture room, receiving the lecture-understanding estimation information of the student from the student-seat terminal or the lecturer-seat terminal, and storing the lecture-understanding estimation information of the student; and
h) receiving, by the lecture-support server, student-attitude report information from the lecturer-seat terminal, and storing the student-attitude report information.

15. The method according to claim 14, further comprising:
if a student card is withdrawn from the student-seat terminal, receiving, by the lecture-support server, a card-withdrawal signal wirelessly transmitted from the student-seat terminal; and
determining, by the lecture-support server, whether an intermediate-termination report of the lecture is contained in a lecture schedule, determining whether the lecture is normally terminated on the basis of the intermediate-termination report, informing the student-seat terminal and the lecturer-seat terminal that the corresponding student has left the lecture room without notice to the lecturer on the condition that the lecture has not been normally terminated, and displaying a student's leaving confirmation message without notice on the student-seat terminal.

16. The method according to claim 15, further comprising:
searching for a lecture schedule of the lecture to determine whether the lecture is continued after the lapse of a predetermined lecture-termination time, and informing the lecturer-seat terminal of the occurrence of overtime of the lecture if it is determined that the lecture is continued after the lapse of the predetermined lecture-termination time.

17. The method according to claim 16, further comprising:
searching for a lecture schedule of the lecture to determine whether the lecture is continued after the lapse of the predetermined lecture-termination time, and informing the student-seat terminal of the occurrence of overtime of the lecture if it is determined that the lecture is continued after the lapse of the predetermined lecture-termination time.

18. The method according to claim 17, further comprising:
transmitting, by the lecture-support server, a lecture-termination signal to the lecturer-seat terminal and the student-seat terminal of the lecture room at a lecture-termination time, and initializing functions of the lecturer-seat terminal and the student-seat terminal.
